(19) United States
(12) Patent Application Publication
(10) Pub. No.: US 2025/0209244 A1
(43) Pub. Date: Jun. 26, 2025

(54) METHOD TO REDUCE THE HARDWARE COSTS OF EXTRACTING POWER PROFILES IN EMULATION BY USING STATISTICAL TECHNIQUES

(71) Applicant: Synopsys, Inc., Sunnyvale, CA (US)

(72) Inventors: Beshara George Elmufdi, Santa Clara, CA (US); Madhavan Narayana Pillai, Montigny le Bretennou (FR); Anup Kumar Sultania, Columbia, MD (US)

(21) Appl. No.: 18/390,410

(22) Filed: Dec. 20, 2023

(51) Int. Cl. G06F 30/3312; G01R 31/3183; G06F 119/06

(52) U.S. Cl. CPC G06F 30/3312; G01R 31/318314; G06F 2119/06

(57) ABSTRACT

A method of determining power consumption of a circuit design includes, in part: determining toggle data associated with each of a first multitude of flip-flops of the design by applying a stimulus during one or more time intervals; selecting a subset of the first multitude of flip-flops based on their toggle data; performing a first hardware emulation of the design after instrumenting each of the subset of the first multitude of flip-flops; identifying a multitude of time periods during which a sum of toggle data associated with the instrumented flip-flops exceeds a threshold count; performing a second hardware emulation of the design for each of the multitude of time periods after instrumenting a second multitude of flip-flops disposed in the design; storing waveform data associated with each of the second multitude of flip-flops in a first memory; and determining the power consumption of the circuit from the stored waveform data.

### TECHNICAL FIELD

The present disclosure relates to determining the power consumption of a circuit design, and more particularly to determining the power consumption of a circuit design using a hardware emulation system.

### BACKGROUND

A hardware emulation system debugs and verifies the functionality of a circuit design by forming an emulation model of the circuit through programming of the programmable devices disposed in the hardware emulation system. The emulation model is representative of the digital circuit being designed and is often described in a hardware description language (e.g., Verilog) that is compiled into a format used by the emulation system.

A hardware emulation system includes hardware and software components which together define the behavior of the emulation model and the digital circuit being verified and/or designed. One implementation of a hardware emulation system uses configurable hardware such as a field-programmable gate array (FPGA). An FPGA is an integrated circuit designed to be programmed by a designer/user after its manufacture and at the field. An FPGA contains an array of programmable logic blocks, memory blocks and a hierarchy of reconfigurable interconnects that enable the realization of the digital design under development.

An emulation system simulates the digital circuit design before tape-out, and obtains information about the digital design to determine if the digital design operates as intended and complies with the required specifications, such as power and speed. The complexity and gate count of current digital circuits have given rise to an increasing use of hardware emulation systems in verifying the functionality of the digital circuit design.

### SUMMARY

A method of determining power consumption of a circuit design, in accordance with one embodiment of the present disclosure, includes, in part: determining toggle data associated with each of a first multitude of flip-flops disposed in the circuit design by applying a stimulus to the circuit design during one or more time intervals; selecting a subset of the first multitude of flip-flops based on their toggle data; performing a first hardware emulation of the circuit design after instrumenting each of the subset of the first multitude of flip-flops; identifying a multitude of time periods during which a sum of toggle data associated with the instrumented flip-flops exceeds a threshold count; performing a second hardware emulation of the circuit for each of the multitude of time periods after instrumenting a second multitude of flip-flops disposed in the circuit design; storing waveform data associated with each of the second multitude of flip-flops in a first memory; and determining the power consumption of the circuit from the stored waveform data.

In one embodiment, the stimulus is applied by a logic simulation software to simulate the circuit design during the one or more time intervals. In one embodiment, the stimulus is applied by a hardware emulation system to emulate the circuit design during the one or more time intervals. In one embodiment, the first multitude of flip-flops includes an entirety of flip-flops disposed in the circuit design, wherein the second multitude of flip-flops includes the entirety of flip-flops disposed in the circuit design.

In one embodiment, the toggle data associated with each of the subset of the first multitude of flip-flops includes, in part, a toggle count of the flip-flop and a fanout of the flip-flop. In one embodiment, the method further includes, in part, configuring the hardware emulation system to form a multitude of toggle detectors, a multitude of toggle counters, a toggle accumulator and a storage control logic.

In one embodiment, the method further includes, in part, stopping the second hardware emulation of the circuit design when the first memory is full; transferring the waveform data stored in the first memory to a second memory after stopping the second hardware emulation; and resuming the second hardware emulation after the waveform data is transferred from the first memory to the second memory. In one embodiment, the toggle data of each of the selected subset of the first multitude of flip-flops is above a threshold toggle data. In one embodiment, the selected subset of the first multitude of flip-flops has a highest toggle data of all the first plurality of flip-flops.

A hardware emulation system, in accordance with one embodiment of the present disclosure, includes, in part, a memory storing instructions; and a processor, coupled with the memory and to execute the instructions. The instructions when executed cause the processor to: receive toggle data associated with each of a first multitude of flip-flops disposed in the circuit design; select a subset of the first multitude of flip-flops based on their toggle data; invoke performance a first emulation run of the circuit design while each of the subset of the first multitude of flip-flops is instrumented; identify a multitude of time periods during which a sum of toggle data associated with the instrumented flip-flops exceeds a threshold value; invoke performance of a second emulation of the circuit for the multitude of time periods while a second multitude of flip-flops disposed in the circuit design are instrumented; and store waveform data associated with each of the second multitude of flip-flops in a first memory.

In one embodiment of the hardware emulation system, the toggle data is determined by a logic simulation software configured to simulate the circuit design during one or more time intervals. In one embodiment of the hardware emulation system, the toggle data is determined by the hardware emulation system during one or more time intervals. In one embodiment of the hardware emulation system, the first multitude of flip-flops includes an entirety of the flip-flops disposed in the circuit design, and the second multitude of flip-flops includes the entirety of flip-flops disposed in the circuit design.

In one embodiment of the hardware emulation system, the toggle data associated with each of the subset of the first multitude of flip-flops includes a toggle count of the flip-flop and a fanout of the flip-flop. In one embodiment, the hardware emulation system is configured to form a multitude of toggle detectors, a multitude of toggle counters, a toggle accumulator and a storage control logic. In one embodiment of the hardware emulation system, the toggle data of each of the selected subset of the first multitude of flip-flops is above a threshold toggle data. In one embodiment of the hardware emulation system, the selected subset of the first multitude of flip-flops have a highest toggle data of all the first plurality of flip-flops

A non-transitory computer readable medium, in accordance with one embodiment of the present disclosure includes stored instructions, which when executed by a processor, cause the processor to: receive toggle data associated with each of a first multitude of flip-flops disposed in the circuit design; select a subset of the first multitude of flip-flops based on their toggle data; invoke performance a first emulation run of the circuit design while each of the subset of the first multitude of flip-flops is instrumented; identify a multitude of time periods during which a sum of toggle data associated with the instrumented flip-flops exceeds a threshold value; invoke performance of a second emulation of the circuit for the multitude of time periods while a second multitude of flip-flops disposed in the circuit design are instrumented; and store waveform data associated with each of the second multitude of flip-flops in a first memory.

In one embodiment, the toggle data is determined by a logic simulation software configured to simulate the circuit design during one or more time intervals. In one embodiment, the toggle data is determined by the hardware emulation system during one or more time intervals.

### DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a block diagram of a power profile logic configured in a hardware emulation system, in accordance with one embodiment of the present disclosure.

FIG. 2 is a line graph showing the increase in the power usage of a circuit design during multiple time windows.

FIG. 3 is a flowchart for determining the power usage of a circuit design, in accordance with one embodiment of the present disclosure.

FIG. 4 depicts a flowchart of various processes used during the design and manufacture of an integrated circuit in accordance with some embodiments of the present disclosure.

FIG. 5 depicts a diagram of an example emulation system in accordance with some embodiments of the present disclosure.

FIG. 6 depicts an example diagram of an example computer system in which embodiments of the present disclosure may operate.

### DETAILED DESCRIPTION

Generating the power profile of an electronic circuit design or a system-on-chip (SoC) prior to manufacturing is a key requirement in many applications. A power profile captures the dynamic power usage of a circuit design, based on the transitions (toggles) of the signals in the circuit design. Generating the power profile of a circuit design with a hardware emulation system requires configuring additional logic to instrument the circuit design, and compiling the additional logic together with the circuit design to enable monitoring of the instrumented signals during the emulation.

The power profile of a circuit design (alternatively referred to herein as design) is often determined by instrumenting and monitoring every flip-flop (flop) disposed in the design. For example, the design may be instrumented, by configuring the programmable logic disposed in the hardware emulation system, to include a toggle detector and a toggle counter at the output of every flop to keep count of the number of toggles of each flop. However, due to the limited resources of a hardware emulation system, monitoring all the flops of a design to determine the power usage of the design is often not practical. The number of hardware resources that need to be instrumented to keep count of the number of toggles in a design may be many times, e.g., 30 times, the number of the flops used in the design. Moreover, monitoring all the flops of a design has a significant adverse effect on the emulation performance, efficiency, as well as the design compile time.

Aspects of the present disclosure relate to determining the power profile of a design in three stages. During the first stage, a stimulus is applied to the design for one or more time intervals to identify nodes or flops whose contributions to the overall power consumption of the design is considered relatively high; such nodes may be alternatively referred to herein as high impact nodes and are described further below. In one embodiment, the stimulus is applied by a logic simulation software tool to simulate the design. In another embodiment, the stimulus is applied by a hardware emulation tool configured to emulate the design in hardware.

During the second stage, the design is hardware emulated and only high impact nodes identified during the first stage are instrumented. The toggle counts of the instrumented nodes are then collected to identify the time periods during which power surges corresponding to peak toggle counts occur. During the third stage, the design is compiled for hardware emulation for full visibility so as to enable the generation of signal waveforms for the design. During the emulation runtime of the third stage, the signal waveforms are stored for the time periods identified during the second stage. The stored waveforms are subsequently analyzed by a power analysis tool to provide an estimate of the power usage of the design. Embodiments of the present disclosure therefore achieve, among other advantages, (i) reduced emulation hardware resources used for instrumentation, (ii) increased emulation frequency, (iii) reduced emulation compile time as well as emulation runtime, and (iv) reduced emulation cost.

In accordance with one aspect of the present disclosure, to estimate the power consumption of a design, during a first stage a stimulus is applied to the design, either using a digital simulation tool or a hardware emulation tool, for one or more relatively fast simulation or emulation run times. If the design is emulated, the nodes with relatively high fanout, and flops disposed in the design are instrumented so as to enable the emulation system to maintain a count of the number of transitions (i.e., toggle counts) associated with each such flop and node for each emulation run. If the design is simulated, the toggle counts for each flop and node with relatively high fanout in the design is collected by the simulation tool. Alternatively, the design may be compiled with full visibility during the first stage. The emulation is then run on the compiled design for short time periods to collect waveforms for the flops and nodes in the design. The toggles may then be extracted from the waveforms, as is described further below.

The fanout cone of a flop (or a node) may be used to determine the power-per-toggle weight (hereinafter weight) associated with the flop or the node. The weight together with the number of toggles of a flop/node may then be used to determine the power consumed by the flop/node. For example, the product of the weight and the number of toggles of a flop/node, as determined during the first stage of the power determination, may be used as a measure of the power consumption of a flop/node. Flops and nodes that have relatively high toggle counts and relatively large fanout consume relatively higher power.

A number of different techniques may then be used to select flops and nodes that consume relatively have high power for instrumentation during the second stage of the power determination. For example, in one embodiment, a percentage of the flops/nodes (e.g., 10%) having the highest power consumption, as determined by their toggle counts and fanout, are instrumented during the second stage of the power estimation. In another embodiment, a toggle threshold count may be used to the select the flops/nodes for instrumentation. For example, flops/nodes with toggle counts of more than, e.g., 100K times, may be selected for instrumentation during the second stage of power determination. In yet another embodiment, a total toggle threshold count may be used to select the flops/nodes. For example, the first set of flops/nodes with the highest toggle count (e.g., 10K) may be selected for the second stage of the power determination. It is understood that any other technique may be used to identify the flops/nodes for the second stage of the power determination.

At the designer/user's discretion, any other nodes of interest that may potentially contribute to a relatively high power usage may be added to the selected flops/nodes in order to compile a list of flops/nodes for instrumentation during the second stage of power determination. Such nodes may be selected by the user based on, for example, previous experience with earlier generations of a design or information from analysis of previous revisions of the same design. During the second stage of the power determination, the design is compiled for hardware emulation and the selected flops/nodes in the compiled list are instrumented. The design is then emulated for a full emulation run during which the toggle count for each of the instrumented nodes is collected.

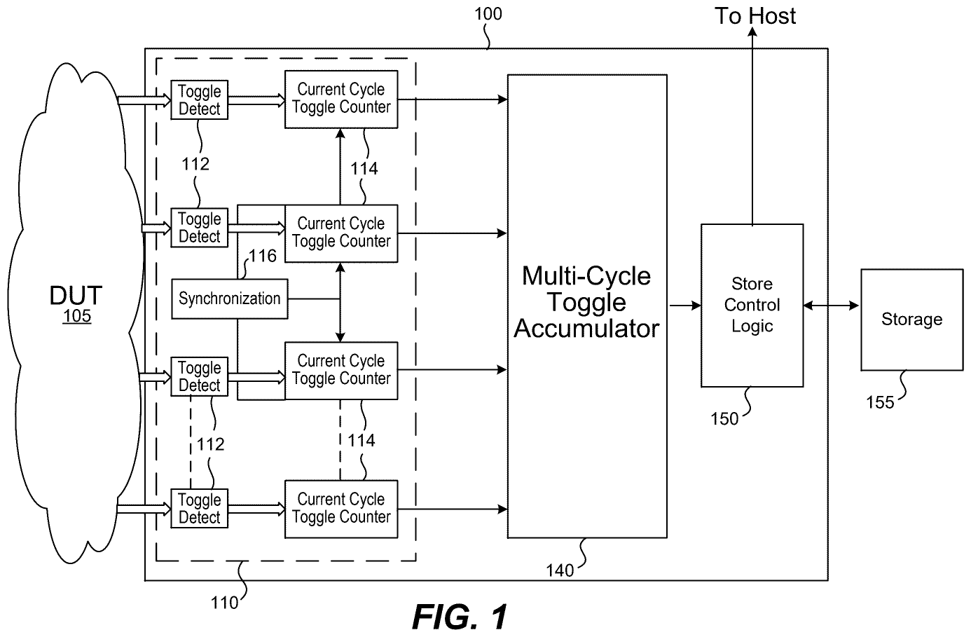

In accordance with one aspect of the present disclosure, the hardware emulation system is further configured to form a power profile logic block adapted to determine the power profile of the design during the second stage of power determination (also referred to herein as power estimation). FIG. 1 is a block diagram 100 of a number of components of power profile logic 100 formed by configuring (i.e., programming) the FPGAs disposed in the emulation system used to emulate the design. Power profile logic 100 is adapted to collect information from the instrumented flops/nodes of the design under test (DUT) 105 to enable the computation of the power profile of DUT 105. Power profile logic 100 is shown as including a capture logic 110, a multi-cycle toggle accumulator 140, and a storage control logic 150. Capture logic 112 is shown as including a multitude of toggle detectors 112, a multitude of toggle counters 114, and a synchronization logic 116.

Each toggle detector 112 is associated with a node that is instrumented in the emulation hardware and is configured to detect a toggle on its associated node. Each toggle counter 114 is associated with a toggle detector and is configured to count the number of toggles on its associated toggle detector. Accordingly, each toggle counter 114 keeps a current count of the number of toggles on the node that is associated with the toggle counter. Synchronization logic 116 is configured to ensure that the toggles counted by the toggle counters and accumulated by toggle accumulator 140 occur during the same emulation cycle, as described further below.

In one embodiment, each toggle counter 114 multiplies the number of toggles of its associated node by the weigh associated with that node to generate a weighted toggle count. As described above, the weight associated with a node may be an integer, a fixed point, or a floating point number determined from the node's fanout and represents the power consumed by the node during each toggle. It is understood that the nodes for which the toggles are counted may be the outputs of flops, combinational logic gates, a memory, a clock tree, and the like.

Toggle accumulator 140 is configured to receive the toggle counts, or the weighted toggle counts (alternatively and collectively referred to herein as toggle data), from toggle counters 114, and generate multiple values representative of the sum of the toggle counts for different groups of components as specified by a user. For example one group of toggles may represent the toggle count for a processor; a different group of toggles may represent the toggle count for a memory controller, and the like. Toggle accumulator 140 delivers the sum so generated to storage control logic 150. Storage control logic 150 may then send the received sum to storage medium 155, which may be a remote host or an onboard memory, for storage and subsequent retrieval at a later time.

In some embodiments, capture logic 110 may capture toggle data one cycle at a time and transmit the captured toggle data to toggle accumulator logic 140. Therefore, in such embodiments, capture logic 110 does not maintain the toggle data from previous emulation cycles, and instead transfers the toggle data in each cycle to toggle accumulator logic 140. When transmitting the toggle data from capture logic 110 to toggle accumulator 140, synchronization logic 116 adds timestamps to the toggle data to indicate the cycle(s) that the toggle data correspond to.

Toggle accumulator 140 is configured to receive the toggle data transmitted from toggle counters 114. Using the timestamps provided by synchronization logic 116, toggle accumulator 140 associates the received toggle data with the toggle data's corresponding emulation clock cycle and stores the toggle data in a local buffer for further analysis. Toggle accumulator 140 may aggregate the toggle data over multiple emulation cycles in order to generate toggle data for such multiple cycles, or may combine the toggle data into a single value.

Toggle accumulator logic 140 delivers the toggle data to storage control logic 150. Storage control logic 150 is configured to transfer the received toggle data to storage medium 155. Storage medium 155 may be a remote a host, or an onboard memory adapted to store the received data for subsequent retrieval and further processing at a later time.

Toggle accumulator logic 140 may optionally mark the toggle data as “interesting” or “not interesting”. Toggle data marked as “interesting” are required for subsequent processing and are therefore transmitted to storage control logic 150. In response, storage control logic 150 causes data marked as “interesting” to be stored in storage medium 155. Toggle data marked as “not interesting” may either be stored or discarded in accordance with a policy defined by a user.

Designation of which data is to be marked as “interesting” and which data is to be marked as “not interesting” may vary from one emulation run to another. A number of different mechanisms may be used to achieve such marking. For example, a trigger signal supplied to toggle accumulator logic 140 may be (i) set to a first value when the data received from capture logic 110 is considered as “interesting”, and (ii) set to a second value when the data received from capture logic 110 is considered as “not interesting”. Toggle accumulator logic 140 may be configured to decide what action to take when the received data is marked as “not interesting”, such as discard the data, transfer the data for storage, or transfer the data for storage only under specified conditions, based on a user defined policy. In other examples, the trigger signal used to mark data as “interesting” or “not interesting” may be based on, for example, a user-defined setting or algorithm.

Storage control logic 150 is configured to transfer the data received from toggle accumulator logic 140 to storage medium 155 where the captured toggle data will be stored for subsequent processing and analysis. Storage control logic 150 may be further configured to convert the data received from toggle accumulator logic 140 to a form that is compatible with the storage requirements of storage medium 155. Storage control logic 150 maintains a record of the location of the storage medium to which storage control logic 150 transfers the data.

In one example, storage medium 155 may be a local memory internal to the FPGAs disposed in the emulation system. In another example, storage medium 155 may be an off-the-shelf dynamic random access memory (DRAM) or static random access memory (SRAM) that is connected to the hardware emulation system. In yet other example, storage medium 155 may be a remote memory.

Storage medium 155 has a storage bandwidth (i.e., the rate at which storage medium 155 can store data) that matches or is higher than the rate at which the toggle data is transferred by storage control logic 150. If the storage bandwidth of storage medium 155 is less than the rate at which data is transferred by storage control logic 150, either the transferred data will not be stored, or the emulation clock is required to be stopped in order to prevent loss of data. Accordingly, storage medium 155 should be suited to have a relatively high bandwidth and high capacity. Double data rate (DDR) memories that are directly connected to the FPGAs of the hardware emulation system provide the required balance between the storage bandwidth (e.g., over 100 Gbps) and capacity (e.g., Gigabytes of data).

It is possible that during the emulation, storage medium 155 runs out of storage capacity. One technique for preventing memory storage overflow is to stop the emulation and copy the stored data into a larger storage, such as a cache hierarchy. For example, if the external DDR memory in which the data is being stored becomes full, the emulation system may be stopped so that the data can be read from the DDR memory and written to a bulk storage, such as a large disk array. Once all the stored data are copied and the DDR becomes empty, the emulation may then resume. In another example, once the storage medium is full, the stored data may be overwritten by new data in a circular buffer fashion. In such examples, it is the responsibility of the user to stop the data capture. When capturing of new data is stopped, the user will have up to the maximum storage capacity of the storage medium worth of new data available.

Power profile logic 100 is, in part, controlled by software instructions issued by a processor disposed in the hardware emulator. Such software may, in part, (i) configure the FPGAs to form the components of power profile logic 100, (ii) provide the weight associated with each instrumented node, (iii) designate the toggle counts that are to be combined, (iv) indicate the number of emulation cycles for which the toggle counts are to be accumulated, (v) provide information about conditions under which to store or transfer the accumulated toggle count, and the like. The software may also control the running of the hardware emulator. For example, if a relatively large number of toggle counts need to be moved from the emulation hardware to another computer or storage, the software may invoke the emulator to start and stop, as needed, in order to manage the movement and storage of the toggle data.

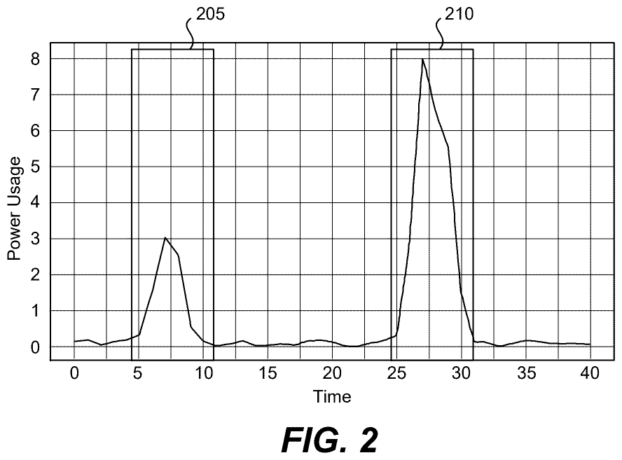

The toggle data collected during the second stage by the power profile logic is then used to determine the time windows during which toggle data peak, thereby resulting in corresponding surges in the power consumption. FIG. 2 is an example of a line graph showing the surge in the power consumption of a circuit undergoing emulation. In FIG. 2, a first power surge is shown as appearing during a first time window 205 between normalized times 5 to 10, and a second power surge is shown as appearing during a second time window 210 between normalized times 20 to 25 seconds. It is understood that FIG. 2 is merely an example and that a line graph often includes a multitude of times windows during which power surges occur. The time windows may be identified by comparing the toggle data, or the corresponding power usage, to one or more user-defined threshold values.

During the third stage of the emulation, the DUT is compiled with full visibility, thus instrumenting all the flops/nodes in order to enable toggle data to be collected for all the flops/nodes in the design. During the third stage, the emulation is run and the waveforms for all the flops/nodes in the design are dumped and stored only for the time windows identified during the second stage of the emulation, as shown for example, in FIG. 2. A power analysis software tool may then be used to estimate the power consumption of the design from the stored data, as is known.

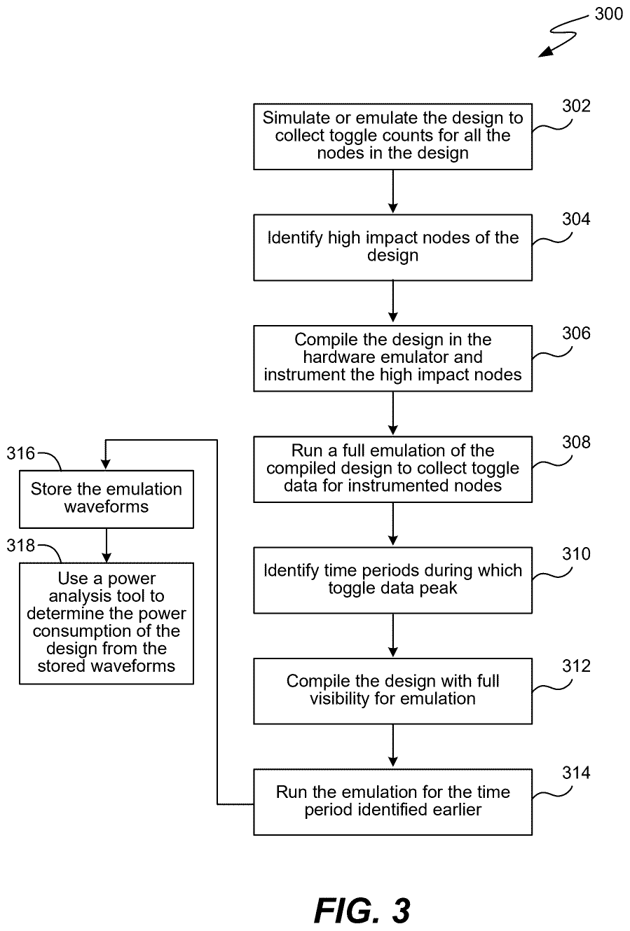

FIG. 3 is a flowchart 300 for estimating the power consumption of a design, in accordance with one embodiment of the present disclosure. At 302, the design is either simulated or emulated for one or more relatively fast simulation or emulation run times to collect toggle data for all the nodes in the design. At 304, high impact nodes and flops of the design, as described in detail above, are identified. At 306, the design is compiled for hardware emulation with the high impact nodes instrumented. The compiled design is then emulated for a full emulation run at 308 during which the toggle data for each of the instrumented nodes is collected. At 310, the collected toggle data are used to identify the time periods during which toggle data peak.

Thereafter, at 312, the design is compiled with full visibility for emulation. At 314, the emulation is run for the time periods identified at 310. The emulation waveforms are then stored for further processing and analysis at 316. A power analysis software tool is then used at 318 to estimate the power consumption of the design from the stored waveforms.

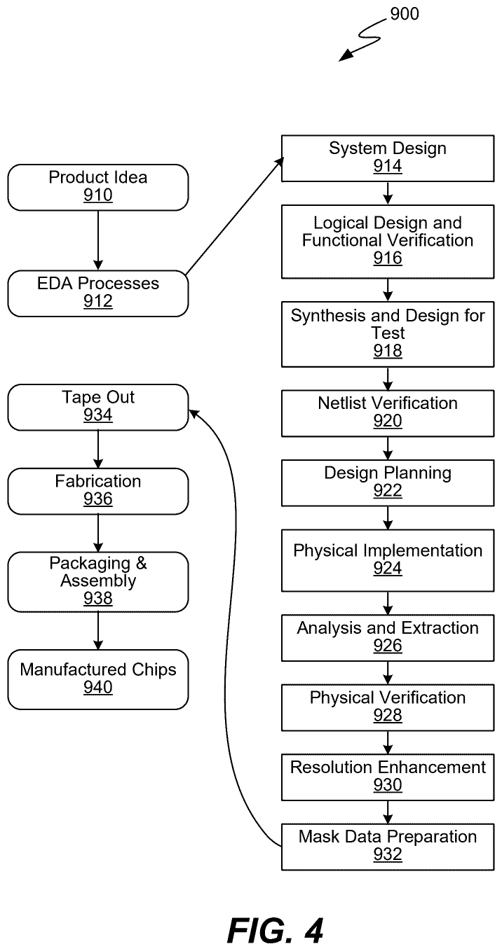

FIG. 4 illustrates an example set of processes 900 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 910 with information supplied by a designer, information which is transformed to create an article of manufacture that uses a set of EDA processes 912. When the design is finalized, the design is taped-out 934, which is when artwork (e.g., geometric patterns) for the integrated circuit is sent to a fabrication facility to manufacture the mask set, which is then used to manufacture the integrated circuit. After tape-out, a semiconductor die is fabricated 936 and packaging and assembly processes 936 are performed to produce the finished integrated circuit 940.

Specifications for a circuit or electronic structure may range from low-level transistor material layouts to high-level description languages. A high-level description may be used to design circuits and systems, using a hardware description language (‘HDL’) such as VHDL, Verilog, System Verilog, SystemC, MyHDL or OpenVera. The HDL description can be transformed to a logic-level register transfer level (‘RTL’) description, a gate-level description, a layout-level description, or a mask-level description. Each lower level description adds more useful detail into the design description, for example, more details for the modules that include the description. The lower levels of description can be generated by a computer, derived from a design library, or created by another design automation process. An example of a specification language at a lower level language for specifying more detailed descriptions is SPICE, which is used for detailed descriptions of circuits with many analog components. Descriptions at each level is enabled for use by the corresponding tools of that layer (e.g., a formal verification tool). A design process may use a sequence depicted in FIG. 4. The processes described by be enabled by EDA products (or tools).

During system design 914, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 916, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 918, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 920, the netlist is checked for compliance with timing constraints and for correspondence with the HDL code. During design planning 922, an overall floor plan for the integrated circuit is constructed and analyzed for timing and top-level routing.

During layout or physical implementation 924, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 926, the circuit function is verified at the layout level, which permits refinement of the layout design. During physical verification 928, the layout design is checked to ensure that manufacturing constraints are correct, such as DRC constraints, electrical constraints, lithographic constraints, and that circuitry function matches the HDL design specification. During resolution enhancement 930, the geometry of the layout is transformed to improve how the circuit design is manufactured.

During tape-out, data is created to be used (after lithographic enhancements are applied if appropriate) for production of lithography masks. During mask data preparation 932, the ‘tape-out’ data is used to produce lithography masks that are used to produce finished integrated circuits.

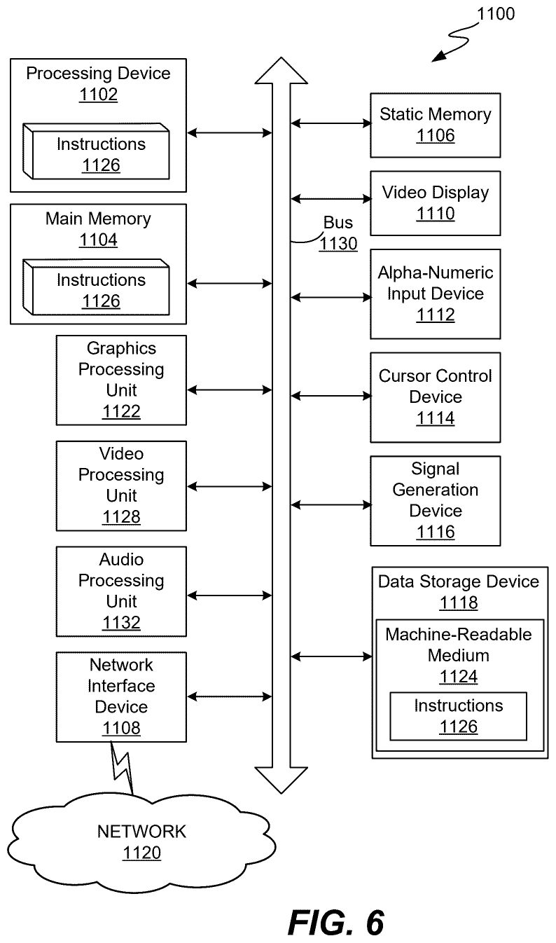

A storage subsystem of a computer system (such as computer system 1100 of FIG. 6) may be used to store the programs and data structures that are used by some or all of the EDA products described herein, and products used for development of cells for the library and for physical and logical design that use the library.

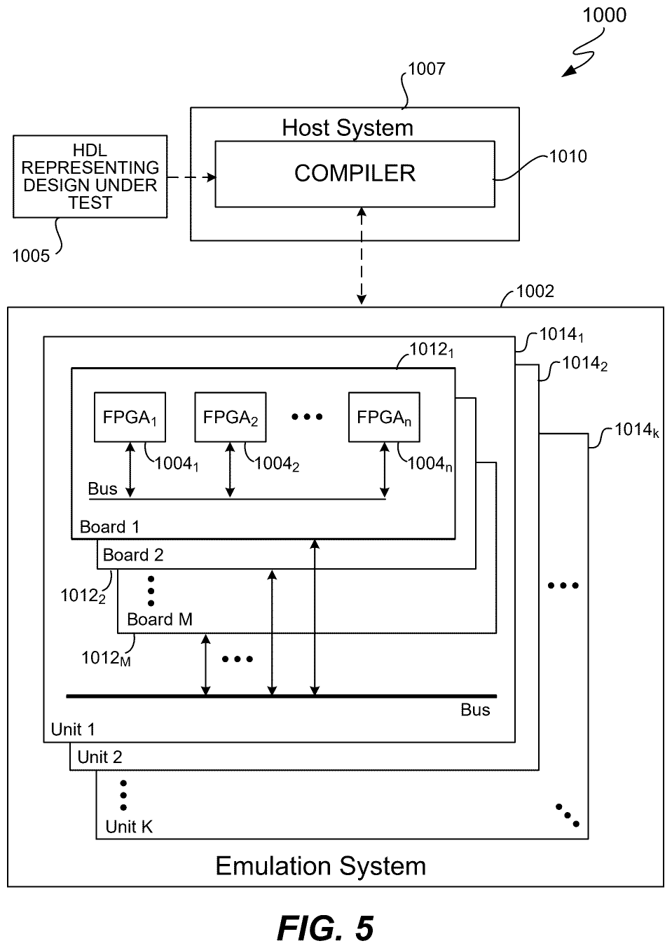

FIG. 5 depicts a diagram of an example emulation environment 1000 with which embodiments of the present disclosure may be implemented. An emulation environment 1000 may be configured to verify the functionality of the circuit design. The emulation environment 1000 may include a host system 1007 (e.g., a computer that is part of an EDA system) and an emulation system 1002 (e.g., a set of programmable devices such as Field Programmable Gate Arrays (FPGAs) or processors). The host system generates data and information by using a compiler 1010 that transforms each of a multitude of flip-flop to a dual-enable flip-flop, as described above, to structure the emulation system to emulate a circuit design. A circuit design to be emulated is also referred to as a Design Under Test (‘DUT’) where data and information from the emulation are used to verify the functionality of the DUT.

The host system 1007 may include one or more processors. In the embodiment where the host system includes multiple processors, the functions described herein as being performed by the host system can be distributed among the multiple processors. The host system 1007 may include a compiler 1010 to transform specifications written in a description language that represents a DUT and to produce data (e.g., binary data) and information that is used to structure the emulation system 1002 to emulate the DUT. The compiler 1010 can transform, change, restructure, add new functions to, and/or control the timing of the DUT.

The host system 1007 and emulation system 1002 exchange data and information using signals carried by an emulation connection. The connection can be, but is not limited to, one or more electrical cables such as cables with pin structures compatible with the Recommended Standard 232 (RS232) or universal serial bus (USB) protocols. The connection can be a wired communication medium or network such as a local area network or a wide area network such as the Internet. The connection can be a wireless communication medium or a network with one or more points of access using a wireless protocol such as BLUETOOTH or IEEE 802.11. The host system 1207 and emulation system 1002 can exchange data and information through a third device such as a network server.

The emulation system 1202 includes multiple FPGAs (or other modules) such as FPGAs 1004₁ and 1004₂ as well as additional FPGAs to 1004_{N}. Each FPGA can include one or more FPGA interfaces through which the FPGA is connected to other FPGAs (and potentially other emulation components) for the FPGAs to exchange signals. An FPGA interface can be referred to as an input/output pin or an FPGA pad. While an emulator may include FPGAs, embodiments of emulators can include other types of logic blocks instead of, or along with, the FPGAs for emulating DUTs. For example, the emulation system 1002 can include custom FPGAs, specialized ASICs for emulation or prototyping, memories, and input/output devices.

A programmable device can include an array of programmable logic blocks and a hierarchy of interconnections that can enable the programmable logic blocks to be interconnected according to the descriptions in the HDL code. Each of the programmable logic blocks can enable complex combinational functions or enable logic gates such as AND, and XOR logic blocks. In some embodiments, the logic blocks also can include memory elements/devices, which can be simple latches, flip-flops, or other blocks of memory. Depending on the length of the interconnections between different logic blocks, signals can arrive at input terminals of the logic blocks at different times and thus may be temporarily stored in the memory elements/devices.

FPGAs 1004₁-1004_{N} may be placed onto one or more boards 1012₁ and 1012₂ as well as additional boards through 1012_{M}. Multiple boards can be placed into an emulation unit 1014₁. The boards within an emulation unit can be connected using the backplane of the emulation unit or any other types of connections. In addition, multiple emulation units (e.g., 1014₁ and 1014₂ through 1014_{K}) can be connected to each other by cables or any other means to form a multi-emulation unit system.

For a DUT that is to be emulated, the host system 1007 transmits one or more bit files to the emulation system 1002. The bit files may specify a description of the DUT and may further specify partitions of the DUT created by the host system 1007 with trace and injection logic, mappings of the partitions to the FPGAs of the emulator, and design constraints. Using the bit files, the emulator structures the FPGAs to perform the functions of the DUT. In some embodiments, one or more FPGAs of the emulators may have the trace and injection logic built into the silicon of the FPGA. In such an embodiment, the FPGAs may not be structured by the host system to emulate trace and injection logic.

The host system 1007 receives a description of a DUT that is to be emulated. In some embodiments, the DUT description is in a description language (e.g., a register transfer language (RTL)). In some embodiments, the DUT description is in netlist level files or a mix of netlist level files and HDL files. If part of the DUT description or the entire DUT description is in an HDL, then the host system can synthesize the DUT description to create a gate level netlist using the DUT description. A host system can use the netlist of the DUT to partition the DUT into multiple partitions where one or more of the partitions include trace and injection logic. The trace and injection logic traces interface signals that are exchanged via the interfaces of an FPGA. Additionally, the trace and injection logic can inject traced interface signals into the logic of the FPGA. The host system maps each partition to an FPGA of the emulator. In some embodiments, the trace and injection logic is included in select partitions for a group of FPGAs. The trace and injection logic can be built into one or more of the FPGAs of an emulator. The host system can synthesize multiplexers to be mapped into the FPGAs. The multiplexers can be used by the trace and injection logic to inject interface signals into the DUT logic.

The host system creates bit files describing each partition of the DUT and the mapping of the partitions to the FPGAs. For partitions in which trace and injection logic are included, the bit files also describe the logic that is included. The bit files can include place and route information and design constraints. The host system stores the bit files and information describing which FPGAs are to emulate each component of the DUT (e.g., to which FPGAs each component is mapped).

Upon request, the host system transmits the bit files to the emulator. The host system signals the emulator to start the emulation of the DUT. During emulation of the DUT or at the end of the emulation, the host system receives emulation results from the emulator through the emulation connection. Emulation results are data and information generated by the emulator during the emulation of the DUT which include interface signals and states of interface signals that have been traced by the trace and injection logic of each FPGA. The host system can store the emulation results and/or transmits the emulation results to another processing system.

After emulation of the DUT, a circuit designer can request to debug a component of the DUT. If such a request is made, the circuit designer can specify a time period of the emulation to debug. The host system identifies which FPGAs are emulating the component using the stored information. The host system retrieves stored interface signals associated with the time period and traced by the trace and injection logic of each identified FPGA. The host system signals the emulator to re-emulate the identified FPGAs. The host system transmits the retrieved interface signals to the emulator to re-emulate the component for the specified time period. The trace and injection logic of each identified FPGA injects its respective interface signals received from the host system into the logic of the DUT mapped to the FPGA. In case of multiple re-emulations of an FPGA, merging the results produces a full debug view.

The host system receives, from the emulation system, signals traced by logic of the identified FPGAs during the re-emulation of the component. The host system stores the signals received from the emulator. The signals traced during the re-emulation can have a higher sampling rate than the sampling rate during the initial emulation. For example, in the initial emulation a traced signal can include a saved state of the component every X milliseconds. However, in the re-emulation the traced signal can include a saved state every Y milliseconds where Y is less than X. If the circuit designer requests to view a waveform of a signal traced during the re-emulation, the host system can retrieve the stored signal and display a plot of the signal. For example, the host system can generate a waveform of the signal. Afterwards, the circuit designer can request to re-emulate the same component for a different time period or to re-emulate another component.

A host system 1007 and/or the compiler 1010 may include sub-systems such as, but not limited to, a design synthesizer sub-system, a mapping sub-system, a run time sub-system, a results sub-system, a debug sub-system, a waveform sub-system, and a storage sub-system. The sub-systems can be structured and enabled as individual or multiple modules or two or more may be structured as a module. Together these sub-systems structure the emulator and monitor the emulation results.

The design synthesizer sub-system transforms the HDL that is representing a DUT 1005 into gate level logic. For a DUT that is to be emulated, the design synthesizer sub-system receives a description of the DUT. If the description of the DUT is fully or partially in HDL (e.g., RTL or other levels of representation), the design synthesizer sub-system synthesizes the HDL of the DUT to create a gate-level netlist with a description of the DUT in terms of gate level logic.

The mapping sub-system partitions DUTs and maps the partitions into emulator FPGAs. The mapping sub-system partitions a DUT at the gate level into a number of partitions using the netlist of the DUT. For each partition, the mapping sub-system retrieves a gate level description of the trace and injection logic and adds the logic to the partition. As described above, the trace and injection logic included in a partition is used to trace signals exchanged via the interfaces of an FPGA to which the partition is mapped (trace interface signals). The trace and injection logic can be added to the DUT prior to the partitioning. For example, the trace and injection logic can be added by the design synthesizer sub-system prior to or after the synthesizing the HDL of the DUT.

In addition to including the trace and injection logic, the mapping sub-system can include additional tracing logic in a partition to trace the states of certain DUT components that are not traced by the trace and injection. The mapping sub-system can include the additional tracing logic in the DUT prior to the partitioning or in partitions after the partitioning. The design synthesizer sub-system can include the additional tracing logic in an HDL description of the DUT prior to synthesizing the HDL description.

The mapping sub-system maps each partition of the DUT to an FPGA of the emulator. For partitioning and mapping, the mapping sub-system uses design rules, design constraints (e.g., timing or logic constraints), and information about the emulator. For components of the DUT, the mapping sub-system stores information in the storage sub-system describing which FPGAs are to emulate each component.

Using the partitioning and the mapping, the mapping sub-system generates one or more bit files that describe the created partitions and the mapping of logic to each FPGA of the emulator. The bit files can include additional information such as constraints of the DUT and routing information of connections between FPGAs and connections within each FPGA. The mapping sub-system can generate a bit file for each partition of the DUT and can store the bit file in the storage sub-system. Upon request from a circuit designer, the mapping sub-system transmits the bit files to the emulator, and the emulator can use the bit files to structure the FPGAs to emulate the DUT.

If the emulator includes specialized ASICs that include the trace and injection logic, the mapping sub-system can generate a specific structure that connects the specialized ASICs to the DUT. In some embodiments, the mapping sub-system can save the information of the traced/injected signal and where the information is stored on the specialized ASIC.

The run time sub-system controls emulations performed by the emulator. The run time sub-system can cause the emulator to start or stop executing an emulation. Additionally, the run time sub-system can provide input signals and data to the emulator. The input signals can be provided directly to the emulator through the connection or indirectly through other input signal devices. For example, the host system can control an input signal device to provide the input signals to the emulator. The input signal device can be, for example, a test board (directly or through cables), signal generator, another emulator, or another host system.

The results sub-system processes emulation results generated by the emulator. During emulation and/or after completing the emulation, the results sub-system receives emulation results from the emulator generated during the emulation. The emulation results include signals traced during the emulation. Specifically, the emulation results include interface signals traced by the trace and injection logic emulated by each FPGA and can include signals traced by additional logic included in the DUT. Each traced signal can span multiple cycles of the emulation. A traced signal includes multiple states and each state is associated with a time of the emulation. The results sub-system stores the traced signals in the storage sub-system. For each stored signal, the results sub-system can store information indicating which FPGA generated the traced signal.

The debug sub-system allows circuit designers to debug DUT components. After the emulator has emulated a DUT and the results sub-system has received the interface signals traced by the trace and injection logic during the emulation, a circuit designer can request to debug a component of the DUT by re-emulating the component for a specific time period. In a request to debug a component, the circuit designer identifies the component and indicates a time period of the emulation to debug. The circuit designer's request can include a sampling rate that indicates how often states of debugged components should be saved by logic that traces signals.

The debug sub-system identifies one or more FPGAs of the emulator that are emulating the component using the information stored by the mapping sub-system in the storage sub-system. For each identified FPGA, the debug sub-system retrieves, from the storage sub-system, interface signals traced by the trace and injection logic of the FPGA during the time period indicated by the circuit designer. For example, the debug sub-system retrieves states traced by the trace and injection logic that are associated with the time period.

The debug sub-system transmits the retrieved interface signals to the emulator. The debug sub-system instructs the debug sub-system to use the identified FPGAs and for the trace and injection logic of each identified FPGA to inject its respective traced signals into logic of the FPGA to re-emulate the component for the requested time period. The debug sub-system can further transmit the sampling rate provided by the circuit designer to the emulator so that the tracing logic traces states at the proper intervals.

To debug the component, the emulator can use the FPGAs to which the component has been mapped. Additionally, the re-emulation of the component can be performed at any point specified by the circuit designer.

For an identified FPGA, the debug sub-system can transmit instructions to the emulator to load multiple emulator FPGAs with the same configuration of the identified FPGA. The debug sub-system additionally signals the emulator to use the multiple FPGAs in parallel. Each FPGA from the multiple FPGAs is used with a different time window of the interface signals to generate a larger time window in a shorter amount of time. For example, the identified FPGA can require an hour or more to use a certain amount of cycles. However, if multiple FPGAs have the same data and structure of the identified FPGA and each of these FPGAs runs a subset of the cycles, the emulator can require a few minutes for the FPGAs to collectively use all the cycles.

A circuit designer can identify a hierarchy or a list of DUT signals to re-emulate. To enable this, the debug sub-system determines the FPGA needed to emulate the hierarchy or list of signals, retrieves the necessary interface signals, and transmits the retrieved interface signals to the emulator for re-emulation. Thus, a circuit designer can identify any element (e.g., component, device, or signal) of the DUT to debug/re-emulate.

The waveform sub-system generates waveforms using the traced signals. If a circuit designer requests to view a waveform of a signal traced during an emulation run, the host system retrieves the signal from the storage sub-system. The waveform sub-system displays a plot of the signal. For one or more signals, when the signals are received from the emulator, the waveform sub-system can automatically generate the plots of the signals.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

FIG. 6 illustrates an example machine of a computer system 1100 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1100 includes a processing device 1102, a main memory 1104 (e.g., read-only memory (ROM), flash memory, dynamic random access memory (DRAM) such as synchronous DRAM (SDRAM), a static memory 1106 (e.g., flash memory, static random access memory (SRAM), etc.), and a data storage device 1118, which communicate with each other via a bus 1130.

Processing device 1102 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1102 may also be one or more special-purpose processing devices such as an application specific integrated circuit (ASIC), a field programmable gate array (FPGA), a digital signal processor (DSP), network processor, or the like. The processing device 1102 may be configured to execute instructions 1126 for performing the operations and steps described herein.

The computer system 1100 may further include a network interface device 1108 to communicate over the network 1120. The computer system 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse), a graphics processing unit 1122, a signal generation device 1116 (e.g., a speaker), graphics processing unit 1122, video processing unit 1128, and audio processing unit 1132.

The data storage device 1118 may include a machine-readable storage medium 1124 (also known as a non-transitory computer-readable medium) on which is stored one or more sets of instructions 1126 or software embodying any one or more of the methodologies or functions described herein. The instructions 1126 may also reside, completely or at least partially, within the main memory 1104 and/or within the processing device 1102 during execution thereof by the computer system 1100, the main memory 1104 and the processing device 1102 also constituting machine-readable storage media.

In some implementations, the instructions 1126 include instructions to implement functionality corresponding to the present disclosure. While the machine-readable storage medium 1124 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 1102 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

What is claimed:

1. A method of determining power consumption of a circuit design, the method comprising:
determining toggle data associated with each of a first plurality of flip-flops disposed in the circuit design by applying a stimulus to the circuit design during one or more time intervals;
selecting a subset of the first plurality of flip-flops based on their toggle data;
performing a first hardware emulation of the circuit design after instrumenting each of the subset of the first plurality of flip-flops;
identifying a plurality of time periods during which a sum of toggle data associated with the instrumented flip-flops exceeds a threshold count;
performing a second hardware emulation of the circuit for each of the plurality of time periods after instrumenting a second plurality of flip-flops disposed in the circuit design;
storing waveform data associated with each of the second plurality of flip-flops in a first memory; and
determining the power consumption of the circuit design from the stored waveform data.

2. The method of claim 1 wherein the stimulus is applied by a logic simulation software to simulate the circuit design during the one or more time intervals.

3. The method of claim 1 wherein the stimulus is applied by a hardware emulation system to emulate the circuit design during the one or more time intervals.

4. The method of claim 1 wherein the first plurality of flip-flops comprises an entirety of flip-flops disposed in the circuit design, and wherein the second plurality of flip-flops comprises the entirety of flip-flops disposed in the circuit design.

5. The method of claim 1 wherein the toggle data associated with each of the subset of the first plurality of flip-flops comprises a toggle count of the flip-flop and a fanout of the flip-flop.

6. The method of claim 1 further comprising configuring the hardware emulation system to form a plurality of toggle detectors, a plurality of toggle counters, a toggle accumulator and a storage control logic.

7. The method of claim 1 further comprising:
stopping the second hardware emulation of the circuit design when the first memory is full;
transferring the waveform data stored in the first memory to a second memory after stopping the second hardware emulation; and
resuming the second hardware emulation after the waveform data is transferred from the first memory to the second memory.

8. The method of claim 1, wherein the toggle data of each of the selected subset of the first plurality of flip-flops is above a threshold toggle data.

9. The method of claim 1, wherein the selected subset of the first plurality of flip-flops has a highest toggle data of all the first plurality of flip-flops.

10. The method of claim 1 further comprising:
performing the second hardware emulation of the circuit after instrumenting a first plurality of nodes disposed in the circuit design, wherein said first plurality of nodes is distinct from the first plurality of flip-flops;
storing waveform data associated with each of the first plurality of nodes in the first memory; and
determining the power consumption of the circuit design from the stored waveform data.

11. The method of claim 10 wherein each of said first plurality of nodes has a fanout that is greater than a threshold value.

12. The method of claim 10 wherein said first plurality of nodes are output ports of a memory disposed in the circuit design.

13. A hardware emulation system comprising:
a memory storing instructions; and
a processor, coupled with the memory and to execute the instructions, the instructions when executed cause the processor to:
receive toggle data associated with each of a first plurality of flip-flops disposed in the circuit design;
select a subset of the first plurality of flip-flops based on their toggle data;
invoke performance a first emulation run of the circuit design while each of the subset of the first plurality of flip-flops is instrumented;
identify a plurality of time periods during which a sum of toggle data associated with the instrumented flip-flops exceeds a threshold value;
invoke performance of a second emulation of the circuit for the plurality of time periods while a second plurality of flip-flops disposed in the circuit design are instrumented; and
store waveform data associated with each of the second plurality of flip-flops in a first memory.

14. The hardware emulation system of claim 13, wherein the toggle data is determined by a logic simulation software configured to simulate the circuit design during one or more time intervals.

15. The hardware emulation system of claim 13, wherein the toggle data is determined by the hardware emulation system during one or more time intervals.

16. The hardware emulation system of claim 13, wherein the first plurality of flip-flops comprises an entirety of flip-flops disposed in the circuit design, and wherein the second plurality of flip-flops comprises the entirety of flip-flops disposed in the circuit design.

17. The hardware emulation system of claim 13, wherein the toggle data associated with each of the subset of the first plurality of flip-flops comprises a toggle count of the flip-flop and a fanout of the flip-flop.

18. The hardware emulation system of claim 13, wherein the hardware emulation system is configured to form a plurality of toggle detectors, a plurality of toggle counters, a toggle accumulator and a storage control logic.

19. The hardware emulation system of claim 10, wherein the toggle data of each of the selected subset of the first plurality of flip-flops is above a threshold toggle data.

20. A non-transitory computer readable medium comprising stored instructions, which when executed by a processor, cause the processor to:
receive toggle data associated with each of a first plurality of flip-flops disposed in the circuit design;
select a subset of the first plurality of flip-flops based on their toggle data;
invoke performance a first emulation run of the circuit design while each of the subset of the first plurality of flip-flops is instrumented;
identify a plurality of time periods during which a sum of toggle data associated with the instrumented flip-flops exceeds a threshold value;
invoke performance of a second emulation of the circuit for the plurality of time periods while a second plurality of flip-flops disposed in the circuit design are instrumented; and
store waveform data associated with each of the second plurality of flip-flops in a first memory.
